(19) United States
(12) Patent Application Publication
(10) Pub. No.: US 2006/0000356 A1
(43) Pub. Date: Jan. 5, 2006

(54) Method for removing acidic gas from raw gas, and additive having corrosion suppressing effect and defoaming effect for addition to amine solution for removing acid gas

(76) Inventors: Yasuyoshi Tomoe, Tokyo (JP); Makoto Shimizu, Tokyo (JP); Mitsuhiro Takarada, Gunma (JP); Teruki Ikeda, Gunma (JP); Yoshitaka Aoki, Gunma (JP)

Correspondence Address: JACOBSON HOLMAN PLLC, 400 SEVENTH STREET N.W., SUITE 600, WASHINGTON, DC, 20004, US

(21) Appl. No.: 10/531,719

(22) PCT Filed: Nov. 26, 2003
(86) PCT No.: PCT/JP03/15083

§ 371 Date: Apr. 18, 2005

(30) Foreign Application Priority Data
Nov. 27, 2002 (JP) 2002-343611

(51) Int. Cl. B01D 53/14

(52) U.S. Cl. 95/236; 423/228

(57) ABSTRACT

A method for removing an acidic gas from a raw gas containing the acid gas by contacting the raw gas with an aqueous alkanol amine solution, characterized in that a composition comprising an organopolysiloxane containing a polyoxyalkylene group and a fine silica powder is caused to be present. In some embodiments, a composition comprising the above-mentioned organopolysiloxane and a fine silica powder is added appropriately according to the state of foaming in an acidic gas removing reaction system from the outside of the system, or use is made of an alkanol amine containing in advance a composition comprising the above-mentioned organopolysiloxane and a fine silica powder. In preferred embodiments, the fine silica powder has a specific surface area of 50 m²/g or more, and/or the composition comprising the above-mentioned organopolysiloxane and a fine silica powder is used in an amount of 0.1 to 5000 ppm relative to the alkanol amine. As a further embodiment, a method for removing an acidic gas from a raw gas by contacting the raw gas with an aqueous alkanol amine solution containing 40 mass % or more of an alkanol amine, characterized in that a composition comprising the above-mentioned organopolysiloxane and a fine silica powder is caused to be present in an amount of 0.1 to 5000 ppm relative to the alkanol amine.

### TECHNICAL FIELD

The present invention relates to a method for removing an acidic gas component from a raw gas, and relates to an additive having antifoaming and corrosion inhibition effects to be added to a high concentration of an amine solution (preferably 2-(2-aminoethoxy)ethanol, referred to as “diglycolamine” hereinafter) for removing an acidic gas such as carbon dioxide and hydrogen sulfide.

### BACKGROUND ART

A natural gas or an offgas produced from oil factory contains water, and an acidic gas such as carbon dioxide and hydrogen sulfide. Water and an acidic gas must be removed to prevent corrosion and obtain heat from a treated gas. An aqueous solution of an amine such as monoethanolamine and diethanolamine has been used for a long time to remove an acidic gas. An attempt to produce a smaller-size apparatus for removing an acidic gas has been made to reduce an operational cost and increase productivity by using a higher concentration of an amine solution. However, when the amine concentration is increased, problem that apparatus materials comprised of carbon steel and stainless steel become corroded occur, and an aqueous diglycolamine solution, considered to be relatively anticorrosive, has been used. However, when an aqueous solution containing 25% or higher of diglycolamine was used, it was observed that the apparatus materials become more corroded. Particularly, it was observed that a stainless steel of an amine regenerating tower, to remove an absorbed acidic gas from an amine solution by heating, was much corroded. High alloy “Carpenter 20Cb3” was used but corrosion could not be prevented.

On the other hand, foaming frequently occurred in an acidic gas absorbing tower in which a natural gas and diglycolamine are countercurrently contacted, and corrosion was increased by an uneven flow of an amine solution. A variety of antifoaming agents were used but they failed. There is a concern that an excessive addition of an antifoaming agent caused an increase in foaming.

Because a corrosion product stabilizes and increases foaming, and foaming increases corrosion, an additive having antifoaming and corrosion inhibition effects has been required.

An addition of chromium as a corrosion inhibition agent is not preferable because chromium is not environmentally acceptable as apparent from the pollution problems caused by hexavalent chromium in recent years. An apparatus for removing an acidic gas, capable of being used for a long period of time and in which a high concentration of a diglycolamine solution can be used, has been demanded. In addition, foaming frequently occurred at a step of removing an acidic gas conducted at a high temperature, and an antifoaming agent was added for increasing productivity. However, there was no effective antifoaming agent. There was a case in which an addition amount of an antifoaming agent was increased to be 5,000 ppm or higher, a silicone component was adhered to the apparatus, and adversely a problem of low-productivity was caused.

There are prior art publications of Kohyo (Jpn. Unexamined Patent Publication) No. 2002-519171 and Kokai (Jpn. Unexamined Patent Publication) No. 7-53206.

The object of the present invention is to provide an additive used for an alkanolamine (referred to an amine hereinafter) solution for removing an acidic gas, which has a corrosion inhibition effect on a material of an apparatus for removing an acidic gas, such as carbon steel and stainless steel, even when the concentration of the amine solution for removing an acidic gas, preferably 2-(2-aminoethoxy)ethanol (referred to as “diglycolamine” hereinafter) is 40% or higher, and which has an antifoaming effect during the acidic gas removing process, and to provide a method for removing an acidic gas component from a raw gas.

### DISCLOSURE OF THE INVENTION

An acidic gas can be effectively removed while foaming is suppressed, and corrosion of an apparatus for removing the gas can be reduced by adding a mixture of an organopolysiloxane having a polyoxyalkylene group, and a fine silica powder to a high concentration of an aqueous amine solution for removing an acidic gas which contains 40% by mass or more of an amine.

Because the organopolysiloxane having a polyoxyalkylene group is dispersed well in water, there is less corrosion of apparatus materials after it has been used for a long period of time, and it can be satisfactorily used in apparatuses comprising carbon steel or stainless steel.

The fine silica powder is used to maintain an antifoaming effect. If the powder has a BET specific surface area of 50 m²/g or more, an antifoaming effect is maintained for a long period of time.

More corrosion inhibition and antifoaming effects can be obtained by adding a surfactant to increase a dispersing property of the mixture of the organopolysiloxane having a polyoxyalkylene group and the fine silica powder in an aqueous solution.

### BRIEF DESCRIPTION OF THE DRAWINGS

FIG. 1 shows a schematic diagram of a unit for removing an acidic gas.

FIG. 2 shows a diagram to compare effects on corrosion of example 1, comparative examples 1 and 2.

FIG. 3 shows a diagram to show a change in foaming caused by using different additives.

FIG. 4 shows the corrosion level before and after addition of the additive of the present invention.

FIG. 5 shows a diagram to compare remaining thickness of SUS304L shell of the regenerating tower before and after 24 months passed.

### THE BEST EMBODIMENT TO WORK THE INVENTION

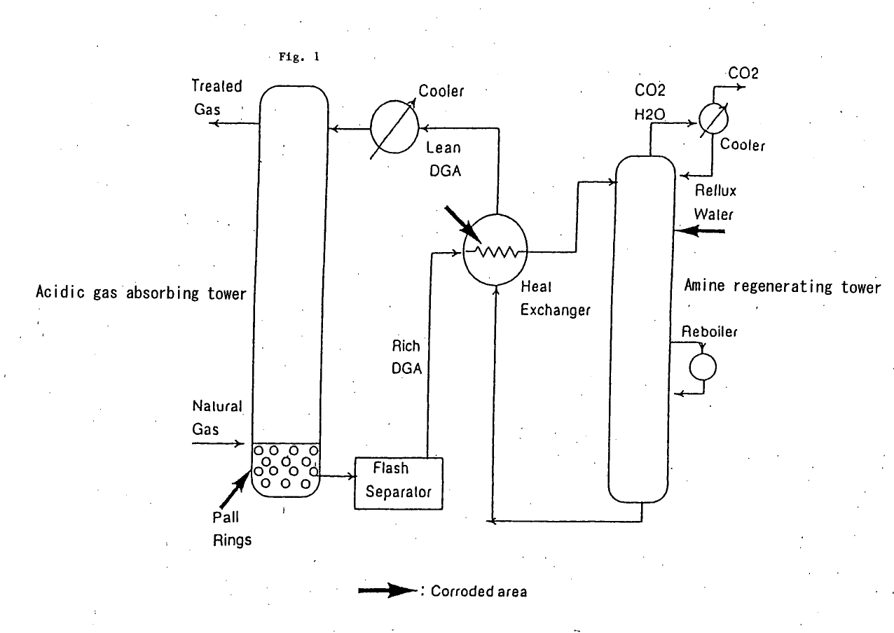

The embodiment of the present invention is explained with the drawings. FIG. 1 shows a schematic diagram of a unit for removing an acidic gas with an aqueous amine solution. An aqueous amine solution for removing an acidic gas, containing 40% by mass or more of an amine, was provided from the top part of an acidic gas absorbing tower, and a natural gas containing an acidic gas was introduced from the bottom part of the absorbing power. When they were countercurrently contacted at 60 to 85° C., a mixture of an organopolysiloxane having a polyoxyalkylene group and a fine silica powder was added whereby an acidic gas was able to be effectively removed while foaming was suppressed and corrosion of the apparatus for removing the gas was reduced.

The present invention is further described as below. An apparatus can be effectively operated by using an aqueous solution, containing 40% by mass or more of an amine, preferably a 60 to 65% by mass aqueous amine solution, as an acidic gas absorbing solution. As a silicone-type additive to be added therein, a mixture of 50 to 99% by mass of an organopolysiloxane, having a polyoxyalkylene group, represented by formula (1) with 1 to 50% by mass of a fine silica powder, having a BET specific surface area of 50 m²/g or more, is useful. With the additive, antifoaming effect can be remarkably improved as compared to the case using a conventional emulsified mixture of dimethylpolysiloxane and a fine silica powder. A corrosion inhibition effect on the apparatus materials such as stainless steel and carbon steel was also recognized.
R¹₂XSi—(R¹₂SiO)ₘ—(R¹₂SiO)ₙ—SiR¹₂X (1)
(provided that R¹ represents a monovalent hydrocarbon group having 1 to 6 carbon atoms; Y represents —R²O—(CₚH₂ₚO)_{q}—R³; X represents an alkoxy group having 1 to 4 carbon atoms, an acyl group, a hydroxyl group, R¹ or Y; R² represents a divalent hydrocarbon group having 3 to 6 carbon atoms; R³ represents a hydrogen atom, a hydrocarbon group having 1 to 4 carbon atoms, or an acyl group; m is an integer of 10 to 200, n is 0 or an integer of 1 to 50, p is an integer of 2 to 4, q is an integer of 5 to 50, provided that when n is 0, X is Y)

The dispersion property of a conventional additive of dimethylpolysiloxane emulsion in a water system is poor at a high temperature, in a basic condition. A silicone oil was precipitated, due to a repeated addition of the additive after an antifoaming effect was reduced, and the silicone oil was adhered to the inside of the apparatus tubes, whereby productivity was adversely reduced. There are additives which increase corrosion of the apparatus materials such as carbon steel and stainless steel. However, it was found that the organopolysiloxane having a polyoxyalkylene group is excellent in dispersing in water, has no problems as described above, there is less corrosion observed in the apparatus materials after the organopolysiloxane having a polyoxyalkylene group had been used for a long period of time, and the organopolysiloxane having a polyoxyalkylene group can be sufficiently used for carbon steel and stainless steel.

A preferable organopolysiloxane having a polyoxyalkylene group, used in the present invention, is represented by formula (1), in which R¹ represents a hydrocarbon group having 1 to 6 carbon atoms. Examples of the hydrocarbon group include an alkyl group such as methyl group, an ethyl group, a propyl group, a butyl group, and a hexyl group, and an aryl group such as a phenyl group. A preferable example is a methyl group. X represents an alkoxy group having 1 to 4 carbon atoms, a hydroxyl group, R¹, or Y which is a group having a polyoxyalkylene group represented by formula (2).
—R²O—(CₚH₂ₚO)_{q}—R³

In the formula, R² represents a divalent hydrocarbon group having 3 to 6 carbon atoms, R³ represents a hydrogen atom, a hydrocarbon group having 1 to 4 carbon atoms, or an acyl group, m is an integer of 10 to 200, n is 0 or an integer of 1 to 50, p is an integer of 2 to 4, q is an integer of 5 to 50, provided that when n is 0, X is Y. The polyoxyalkylene group includes a polyoxyethylene, polyoxypropylene or polyoxybuthylene unit, which can be a copolymer comprising at least one of the units. Particularly, an organopolysiloxane having 8% by mass or more of an organic group having the polyoxyethylene group in which p is 2 is preferably used, when dispersion thereof in the acid gas absorbing solution is considered.

M represents an integer of 10 to 200. When m is less than 10, an antifoaming property is poor, and when m is more than 200, the viscosity of the solution becomes high and workability is reduced, both of which are not preferable. m preferably ranges from 15 to 150. n is preferably 0 or an integer of 1 to 50. When n is 0, a polyoxyalkylene-containing group represented by formula (2) is present at both ends thereof. When n is more than 50, siloxane segments in the entire structure are reduced whereby an antifoaming property becomes poor, which is not preferable. q is preferably an integer of 5 to 50. When q is less than 5, dispersing property in water becomes poor, and when q is more than 50, an antifoaming property is reduced, both of which are not preferable. Particularly, q is preferably 7 to 40 when antifoaming and dispersing properties are considered. Examples include the compounds represented as below, in which Me represents a methyl group, EO represents an oxyethylene group, and PO represents an oxypropylene group.

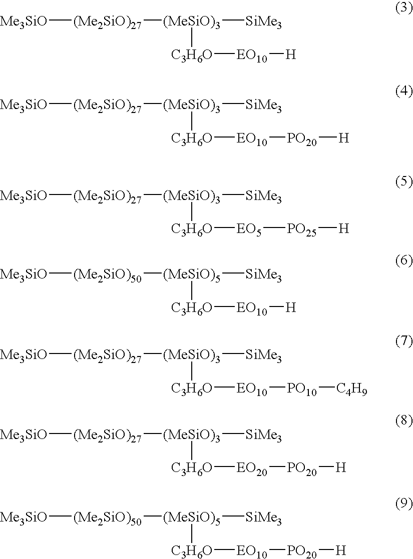

It is preferable that, as a material to exhibit an antifoaming property, a mixture of 50 to 99% by mass of the organopolysiloxane having a polyoxyalkylene group, represented by formula (1) and 1 to 50% by mass of the fine silica powder having a BET specific surface area of 50 m²/g or more is present in an amount of 0.1 to 5000 ppm in the additive for removing an acidic gas. The fine silica powder is used to maintain an antifoaming property. The type of the fine silica powder is not limited as long as it has a BET specific surface area of 50 m²/g or more. The fine silica powder to be used may be wet or dry silica. Examples of the fine silica powder include precipitated silica, silica xerogel, humed silica and silica comprising a surface modified by an organic silyl group, specifically aerogel (Nippon Aerogel K. K. Trade Name), Nipsil (Nippon Silica K. K. Trade Name), and Cabosil (Cabot Trade Name) The fine silica powder preferably has a BET specific surface area of 50 m²/g or more. If a BET specific surface area thereof is less than 50 m²/g, an antifoaming property is reduced. Particularly, the silica having a BET specific surface area of 100 m²/g or more is preferable in terms of an antifoaming property. The mixing ratio of the organopolysiloxane having a polyoxyalkylene group to the fine silica powder is preferably 50 to 99/50 to 1% by mass in terms of workability and a stable antifoaming property. If the fine silica powder accounts for less than 1% by mass, an antifoaming property cannot be maintained. If it accounts for more than 50% by mass, the mixture with the organopolysiloxane having a polyoxyalkylene group becomes highly viscous, and is not industrially applicable. Particularly, the preferable content of the fine silica powder is 2 to 40% by mass.

A surfactant can be added to be contained in an amine solution for removing an acidic gas to improve dispersion of the mixture of the organopolysiloxane having a polyoxyalkylene group and a fine silica powder in the aqueous solution. The surfactant to be used includes a nonionic, cationic, or anionic surfactant, preferably a nonionic surfactant in terms of dispersion. Examples thereof include polyoxyethylene alkylether, polyoxyethylene alkylphenylether, a sorbitan fatty acid ester, a glycerin fatty acid ester, a sucrose fatty acid ester, a polyoxyethylene higher fatty acid ester, a polyoxyethylene ricinus ester, an alkylbenzene sulfonic acid salt, and a higher alkylsulfonic acid salt. When these surfactants are used, a mixture having a specific blending amounts of 50 to 98% by mass of the organopolysiloxane having a polyoxyalkylene group, represented by formula (1), 1 to 50% by mass of the fine silica powder having a BET specific surface area of 50 m²/g or more, and 1 to 40% by mass of a surfactant. If an added amount of a surfactant is more than 40% by mass, an antifoaming property is reduced which is not preferable.

The present invention further provides a method for removing an acidic gas by providing an amine solution for removing an acidic gas, which is an aqueous solution containing 40% by mass or more of an amine and comprises a mixture of the organopolysiloxane having a polyoxyalkylene group and the fine silica powder in an amount of 0.1 to 5000 ppm, from the top part of an acid gas absorbing tower, introducing a natural gas containing an acidic gas from the bottom part of the absorbing tower, and subjecting them to countercurrent contact at 60 to 85° C. (see FIG. 1). In the step, an acidic gas is absorbed into an amine. The aqueous amine solution which absorbed an acidic gas goes out of the bottom part of the tower, is introduced to the top part of an amine regenerating tower, and is heated to 90 to 136° C. by countercurrent contact in the regenerating tower with steam from a reboiler where an acidic gas is removed from an aqueous amine solution. The aqueous solution which released an acidic gas is delivered to the reboiler, and is then returned to the bottom part of the regenerating tower in the form of two-phase stream of steam and the aqueous amine solution heated to a high temperature. The aqueous amine solution at a high temperature goes out of the bottom of the tower, and is introduced again into the absorbing tower after cooled. As described above, stainless steel is corroded in the operation under severe conditions for a long period of time.

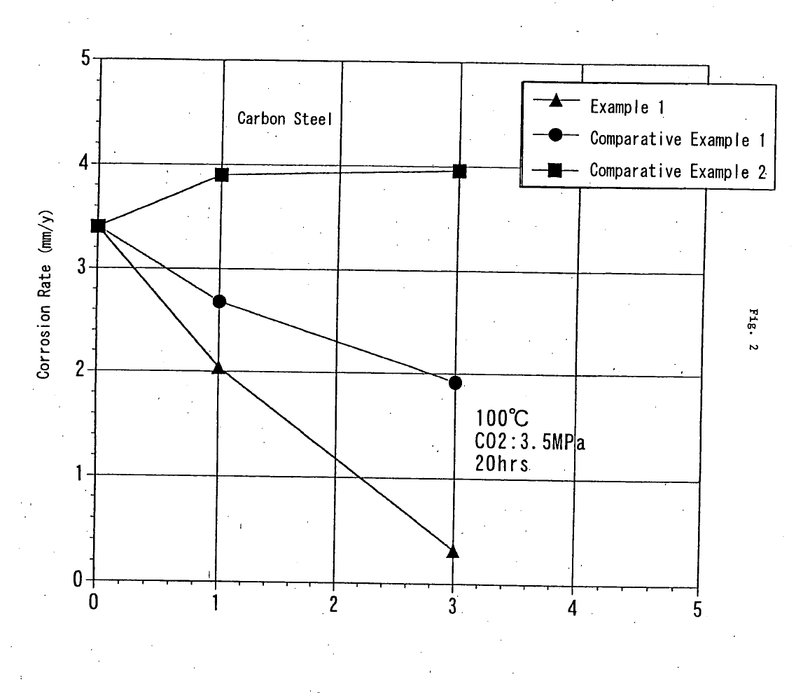

However, it was found that corrosion can be remarkably reduced by using an additive for an amine solution for removing an acidic gas of the present invention. Corrosion environment was produced in a test tube contained in an autoclave in a laboratory to determine corrosion inhibition effect by dipping a carbon steel test piece therein. A corrosion rate was calculated based on a reduced mass of the carbon steel piece after the dipping test. The result is shown in FIG. 2. Corrosion was increased by adding 1% silicone emulsion 1 of comparative example 2 (to be described below). Corrosion was further increased by adding 3% silicone emulsion 1 of comparative example 2. Corrosion was suppressed by adding silicone mixture 2 of comparative example 1 (to be described below). The suppression effect was increased as a concentration of the additive was increased. Corrosion was remarkably suppressed by adding the silicone mixture 1 of example 1 (to be described below). A corrosion rate was reduced by 1/10 by adding 3% silicone mixture 1 of example 1.

The mechanism of anticorrosion has not been elucidated. However, it is presumed that a mixture, of the present invention, of the organopolysiloxane having a polyoxyalkylene group and the fine silica powder, was thermally decomposed during the operation of the apparatus to form a water-repellent methyl siloxane protective film on the surface of carbon steel and stainless steel of apparatus materials, whereby an anticorrosion property was exhibited.

On the other hand, it was determined that foaming, which frequently occurred from the beginning of the operation in an acidic gas absorbing tower in which a natural gas and an aqueous amine solution is countercurrently contacted, causing various problems such as low workability, was reduced by using an additive for a solution for removing an acidic gas of the present invention. It is presumed that foaming was suppressed because the mixture, of the present invention, of the organopolysiloxane having a polyoxyalkylene group and the fine silica powder has a remarkable antifoaming property, and an amount of a silicone adhered to the apparatus was reduced due to a reduced amount of the additive added to the aqueous amine solution.

### EXAMPLES

The present invention is further described with examples, but is not limited thereto.

### Example 1

Using an acidic gas absorbing apparatus shown in FIG. 1, continuous operation for a long period of 24 months to remove an acidic gas was conducted, by using a natural gas produced in the Minami Nagaoka gas field (containing about 6% of a carbonic acid gas and about 5 ppm hydrogen sulfide), and 28 kl of an aqueous 65% diglycolamine solution as an acidic gas absorber and by adding a mixture (silicone mixture 1), as an antifoaming additive, of 250 ml of a mixture (silicone mixture A) which comprises 85 parts by mass of an organopolysiloxane having a polyoxyalkylene group, represented by formula (5), 5 parts by mass of polyoxyethylene nonylphenylether (EO 10 mole), and 10 parts by mass of Aerogel 200 (Nippon Aerogel K. K. Trade Name, having a specific surface area of 200 m²/g), with 1750 ml of water, from the top part of the acidic gas absorbing tower, based on foaming state in the acidic gas absorbing tower.

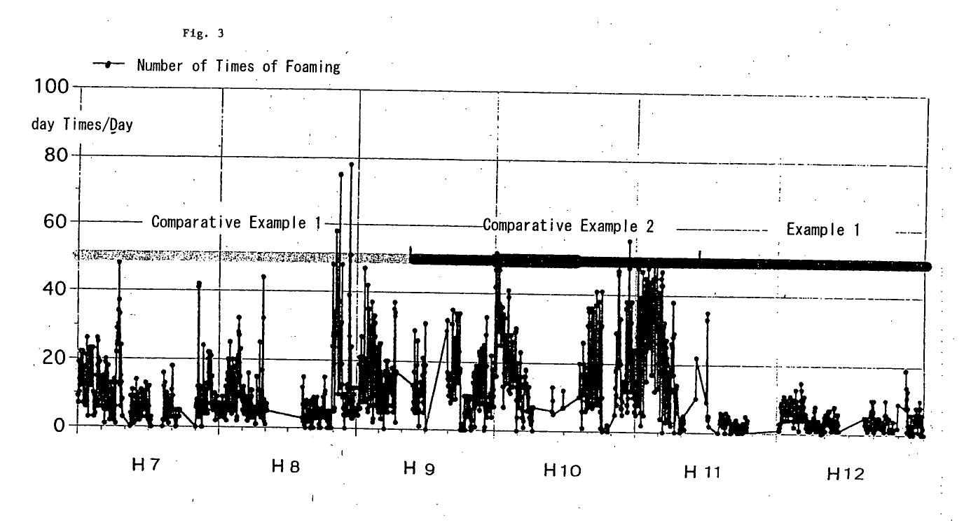

FIG. 3 shows numbers of addition times of the silicone mixture 1 per day (example 1). It is clear that except for the time periods shortly after starting filling, the number of addition times of the silicone mixture 1 is kept to be small, ranging from 5 to 15 times per day, and it is recognized that the silicone mixture A has a remarkably effective antifoaming effect.

Against foaming in the operation, 12.5 ml of the above-described silicone mixture 1 was diluted with water and added. An amount of an aqueous 65% diglycolamine solution is 28 kl. The change in number of times of the silicone 1 mixture addition is shown in FIG. 3. Except for the time period shortly after starting filling, the number of times for filling per day (equals to the number of times of foaming) was kept to be small ranging from several to several dozen times (in this apparatus for removing an acidic gas). It was determined that the additive has a remarkably effective antifoaming effect.

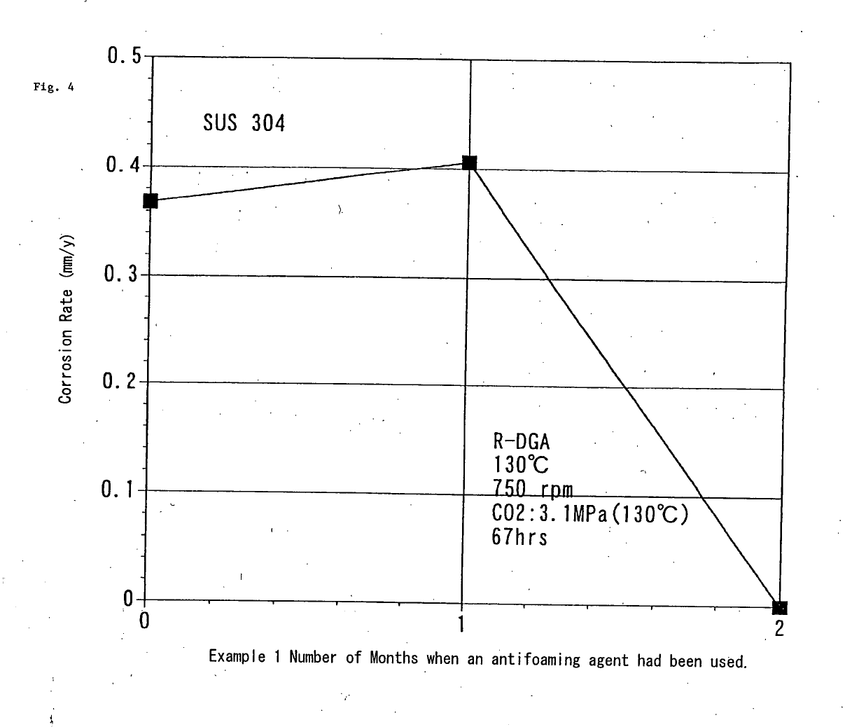

An aqueous diglycolamine solution which had absorbed an acidic gas was collected from the plant immediately, one month and two months after starting addition of the silicone mixture 1, and change in corrosion level of stainless steel was determined. The collected aqueous diglycolamine solution was put in an autoclave and a cell to which a test piece was attached was rotated at a high speed at a high temperature and in a stream of carbonic acid gas to calculate the corrosion rate based on a reduced mass of the test piece. The result is shown in FIG. 4. It was observed that corrosion was relatively increased one month after starting addition of the silicone mixture 1, but was effectively suppressed two months after starting the addition. The result proved a corrosion inhibition effect acted on stainless steel.

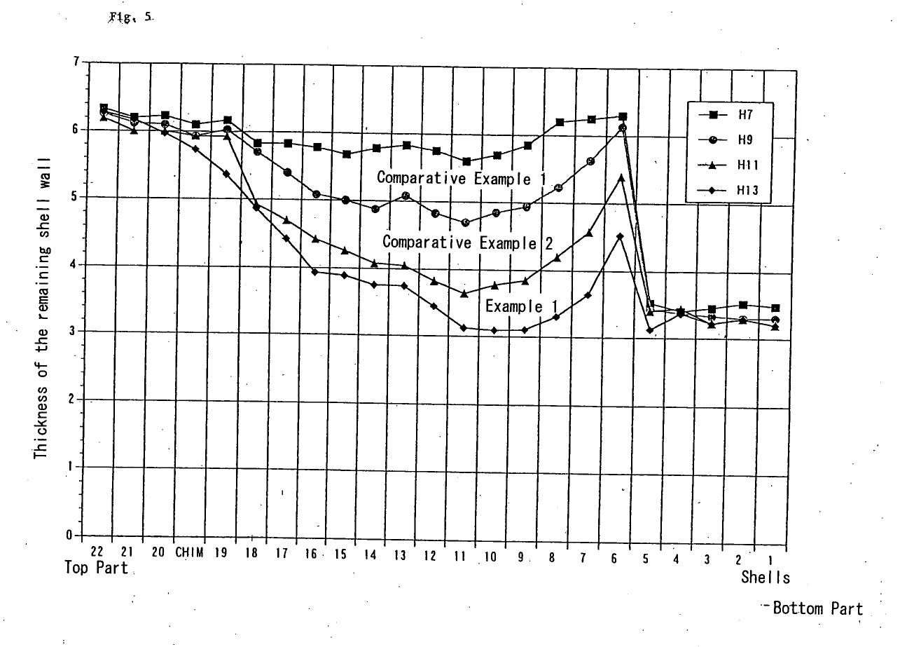

A thickness of a remained steel (SUS 304L steel) of the regenerating tower shell 24 months after starting the addition was determined. The result is shown in FIG. 5. The abscissa of FIG. 5 indicates the number assigned to each shell of the regenerating tower. The smaller numbers indicate lower shells. The ordinate indicates a remained thickness in mm. H7 to H13 indicate the years when the remained thicknesses of the regenerating shell were measured. H7 indicates that the measurement was made in heisei 7^{th}. H13 indicates that the measurement was made in heisei 13^{th}. When the silicone mixture 1 was added, thickness reduction proceeded from H11 to H13. As compared to comparative examples 1 and 2 in which thickness reduction proceeded from H7 to H9, and H9 to H11, respectively, it was determined that thickness reduction was suppressed in example 1 using the silicone mixture 1. Particularly, it was remarkable at the shells higher than the 11^{th} at lower temperatures. It was proved that the silicone mixture 1 has a corrosion inhibition effect in the apparatus.

### Comparative Example 1

Using an acidic gas absorbing apparatus shown in FIG. 1, continuous operation for a long period of 24 months to remove an acidic gas was conducted, by using a natural gas produced in the Minami Nagaoka gas field (containing about 6% of a carbonic acid gas and about 5 ppm of hydrogen sulfide), and 28 kl of an aqueous 65% diglycolamine solution as an acidic gas absorber and by adding a mixture (silicone mixture 2), as an antifoaming additive, of 170 ml of a mixture (silicone mixture B) which comprises 94 parts by mass of an organopolysiloxane having a polyoxyalkylene group represented by formula (5), and 6 parts by mass of polyoxyethylene nonylphenylether (EO 10 mole), with 1830 ml of water, from the top part of the acid gas absorbing tower, based on foaming state in the acid gas absorbing tower.

FIG. 3 shows numbers of addition times of the silicone mixture 2 per day (comparative example 1). In the period, because there is a low level of contamination in the plant, the number of addition times of the additive based on the foaming state was small such as 15 to 20 times per day. However, the number was sometimes increased to 30 to 50 times per day. In the later period of the operation, the number was more than 75 times per day and it was determined that foaming cannot be reduced.

The average number of addition times per day of the silicone mixture 2 (which equals to the times of foaming) was 20 and several. However, in the later period of the operation, it was more than 70 and it was determined that the mixture 2 was not effective to reduce foaming which was required to operate the plant safely.

The thickness of a remaining steel (SUS 304 L steel) of the regenerating tower shell 24 months after starting the addition was determined. The result is shown in FIG. 5. When the silicone mixture 2 was used, thickness reduction proceeded from H7 to H9. It was recognized that corrosion, beyond the acceptable level, proceeded at the broader level of the shells 7 to 1.

### Comparative Example 2

Using an acidic gas absorbing apparatus shown in FIG. 1, continuous operation for a long period of 24 months to remove an acidic gas was conducted, by using a natural gas produced in the Minami Nagaoka gas field (containing about 6% of a carbonic acid gas and about 5 ppm of hydrogen sulfide), and 28 kl of an aqueous 65% diglycolamine solution as an acidic gas absorber, and adding a mixture (silicone mixture 3), as an antifoaming additive, of 250 ml of a mixture (silicone emulsion 1), obtained by adding and emulsifying 100 parts by weight of a mixture comprising 90 parts by mass of dimethylpolysiloxane having a viscosity of 1000 mm²/s, and 10 parts by mass of fine silica powder NipsilHD-2 (Nippon Silica K. K. Trade Name; having a specific surface area of 300 m²/g), 15 parts by weight of sorbitan monostearate, 20 parts by mass of polyoxyethylene monostearate (EO 55 moles) and 315 parts by mass of water, with 1750 ml of water from the top part of the acidic gas absorbing tower, based on foaming state in the acidic gas absorbing tower.

FIG. 3 shows the number of addition times of the silicone mixture 1 per day (comparative example 2). In the period, there was a short period of time in which the number of addition times of the additive based on the foaming state was small such as 10 to 15 times per day. However, in the most of the period, the number was changed at a high level within 30 to 50 times per day, and it was determined that the number was not acceptable.

Against foaming during the operation, 62.5 ml of the above-described silicone emulsion 1 was diluted with water to be added. The amount of the aqueous 65% diglycolamine solution was 28 kl. FIG. 3 shows a change in number of addition times. The number of addition times of the silicone emulsion 1 (which equals to the number of foaming times) was 15 to 50. However, in the later period, the number was more than 50 where it was difficult to operate the plant safely. It was determined that an antifoaming effect was not enough.

A thickness of a remaining steel (SUS 304L steel) of the regenerating tower shell 24 months after starting the addition was determined. The result is shown in FIG. 5. It was observed that corrosion, beyond the acceptable level, occurred at the broader level than example 1 and comparative example 1, at the shells 6^{st} to 18^{th}. As a whole, the corrosion rate was faster than comparative example 1 and the effect against corrosion was not satisfactory.

1. A method for removing an acidic gas component from a raw gas, comprising contacting a raw gas containing an acidic gas component to an aqueous alkanolamine solution, wherein a composition comprising an organopolysiloxane having a polyoxyalkylene group and a fine silica powder is present.

2. The method for removing an acidic gas component from a raw gas according to claim 1, wherein a composition comprising an organopolysiloxane having a polyoxyalkylene group and a fine silica powder is optionally added, based on foaming state in a system of removing an acidic gas, from the outside system.

3. The method for removing an acidic gas from a raw gas according to claim 1, wherein an aqueous alkanolamine solution in which a composition comprising an organopolysiloxane having a polyoxyalkylene group and a fine silica powder had been contained is used.

4. The method for removing an acidic gas component from a raw gas according to claim 1, wherein the specific surface area of the fine silica powder is 50 m²/g or more.

5. The method for removing an acidic gas component according to claim 1, wherein the composition comprising an organopolysiloxane having a polyoxyalkylene group and a fine silica powder is in an amount of 0.1 to 5000 ppm based on the aqueous alkanolamine solution.

6. An additive for an amine solution for removing an acidic gas, to be added to an amine solution for removing an acidic gas with an aqueous solution containing 40% by mass or more of an alkanolamine (referred to as an amine hereinafter), wherein the composition comprising an organopolysiloxane having a polyoxyalkylene group and a fine silica powder is present in an amount of 0.1 to 5000 ppm.

7. The additive for an amine solution for removing an acidic gas according to claim 6, which is a mixture of 50 to 99% by mass of an organopolysiloxane having a polyoxyalkylene group, represented by formula (1), and 1 to 50% by mass of a fine silica powder having a specific surface area of 50 m²/g or more
R¹₂XSi—(R¹₂SiO)ₘ—(R¹YSiO)ₙ—SiR¹₂X (1)
(provided that R¹ represents a monovalent hydrocarbon group having 1 to 6 carbon atoms; X represents an alkoxy group having 1 to 4 carbon atoms, a hydroxyl group, R¹ or Y; Y represents —R²O—(CₚH₂ₚO)_{q}—R³; R² represents a divalent hydrocarbon group having 3 to 6 carbon atoms; R³ represents a hydrogen atom, a hydrocarbon group having 1 to 4 carbon atoms, or an acyl group; m is an integer of 10 to 200, n is 0 or an integer of 1 to 50, p is an integer of 2 to 4, q is an integer of 5 to 50, provided that when n is 0, X is Y)

8. The additive for an amine solution for removing an acidic gas according to claim 6, composed of a mixture of 50 to 98% by mass of an organopolysiloxane having a polyoxyalkylene group, represented by formula (1), 1 to 50% by mass of a fine silica powder having a BET specific surface area of 50 m²/g or more, and 1 to 40% by mass of a nonionic surfactant.
